(19) United States
(12) Patent Application Publication
(10) Pub. No.: US 2016/0053526 A1
(43) Pub. Date: Feb. 25, 2016

(54) TAMPER-PROOF WALL SAFE WITH COMMUNICATIONS CAPABILITIES

(71) Applicant: H. Jason Dittrich, Beverly Hills, MI (US)

(72) Inventor: H. Jason Dittrich, Beverly Hills, MI (US)

(21) Appl. No.: 14/467,801

(22) Filed: Aug. 25, 2014

(51) Int. Cl. E05G 1/04; E05G 1/026

(52) U.S. Cl. CPC E05G 1/04; E05G 1/026

(57) ABSTRACT

A secure safe system with tamper detection includes an enclosure having an outer surface and an inner compartment accessible through a door, and a door lock mechanism. An access device is provided for unlocking the door lock mechanism, thereby enabling a user to gain access to the compartment. An electronic controller, disposed within the enclosure, is interconnected to the access device and the door lock mechanism. The controller is operative to receive a signal from the access device and unlock the door lock mechanism for an authorized user. The outer surface of the enclosure is touch sensitive, and the controller is further operative to determine if a person has touched the touch-sensitive surface and, if so, cause a safe-related function to be performed. The outer surface of the enclosure may be metallic or covered or coated with a touch-sensitive surface. The access device is also preferably touch-sensitive.

### FIELD OF THE INVENTION

This invention relates generally to safes, including wall safes, floor safes and free-standing safes and safe inserts with multiple security features.

### BACKGROUND OF THE INVENTION

Until 1820, safes, or so-called “iron chests,” were designed to protect against burglars, but not fire. Safes that successfully protected against major building fires were not marketed until the early 1840s. After that, safes were routinely used in offices to protect against both fire and burglars. (See www.officemuseum.com or www.earlyofficemuseum.com.)

In 1826, Jesse Delano patented one of the earliest commercial fire-proof safes wherein a wooden enclosure was coated with a composition of clay and lime, plumbago and mica, or saturating the wood in a solution of potash lye and alum, to render it incombustible. In 1833, C. J. Gayler patented a ‘double’ fire-proof chest that consisted of two enclosures with spaces between them to enclose air or any known non-conductors of heat.

In 1830, Daniel Fitzgerald of New York patented a reliable fire proof safe using plaster of Paris as an insulating material. Fitzgerald was granted U.S. Pat. No. 3,117 on Jun. 1, 1843, for an “improvement in fire-proof chests and safes,” specifically the construction of what the patent identifies as a “Salamander Safe” made of heavy iron plates and filled with a three-inch layer of plaster of Paris in liquid form. Fitzgerald assigned the patent to Enos Wilder, who left it to his heir, Benjamin G. Wilder, and it became known as the “Wilder patent.” Between 1840 and 1860, numerous companies in New York City and Boston manufactured fire-proof Salamander safes under the Wilder patent.

Around 1870, Herring & Co. began to construct burglar-proof safes using boiler-plate wrought iron, with an inner safe of hardened steel, and then filled the space between with a casting of Franklinite, the hardest of all known metallic ores, which in casting was incorporated with rods of soft steel, those on one side running vertically, and those on the other horizontally. It was said that the castings resist the best drills for many hours. This proved the most complete protection against burglars so far invented.

Safes have evolved substantially since the nineteenth century. U.S. Pat. No. 6,040,771 describes “an intelligent safe system” that includes a housing, a lockable door and a central processing unit that controls access to the safe by operating the lockable door. The system further includes a card reader for reading access codes from an access card to control the lockable door and a sensor for detecting security violations. A modem transmits alarm signals from the CPU to indicate a security violation and for receiving external control data to lock or open the lockable door, and an audio alarm device indicates security violations. The central processing unit may further include a memory for storing the card numbers. A sensor may be coupled to the housing for detecting the locking an opening of the lockable door. A display may also be coupled to the housing for displaying acceptance of access codes. The sensor may include a horizontal detection sensor for detecting horizontal movement of the housing, a shock-detection sensor for detecting shock inflicted to the safe, and a thermo-detection sensor for detecting thermo-conditions being inflicted to the safe.

Though not a safe, the Gun Box (Lehi, Utah) is a handgun storing box that uses an on-board RFID scanner that syncs with a wristband/ring that has RFID chip for this specific functionality and with one wave over the box provides instant access to the contents. Apart from the RFID identification technique the Gun Box also opens using biometric fingerprint recognition and features alert notifications that send SMS text to a phone if it is tampered with, opened or moved from its original storage location. If stolen, in-built GPS technology will show its precise current location.

Despite such advances, safes that are used to secure firearms or valuables in a home have a flaw in pragmatic use. For example, a homeowner is sleeping at night and is awoken to the sounds of someone breaking into their home. Very likely the home is dark. The homeowner has a choice of turning on the light to access their safe and thereby inadvertently alerting the perpetrator(s) to their awareness of the break-in as well as his/her location. The home owners other option is to leave the lights off, causing him/her to fumble around in an attempt to access the safe in the dark, thereby loosing critical time for action, or not being able to open the safe in time at all.

Further, existing digital keypads (biometrics, etc.) can be compromised over a period of time by testing different codes/pins or access methods. Sometimes standard safes may have a notification that consists of a small warning light or an audible beeping upon next access. The problem with these methods are that the warning 1.) is only available when standing at the safe itself, 2.) temporary, as the notification clears itself out upon next access, and 3.) non-specific, only letting the owner know there was some kind of attempt, and 4.) most importantly, may not be noticed for a by the owner for a long time after the event, if at all. Some safes have a “lock-out” function, whereas after a factory specified number of failed attempts (3 to 5) the safe disallows another attempt for a specified amount of time, usually 60 seconds to 5 minutes. After the “lock-out” clears, more access attempts can be made. The owner would never know how many attempts were made or how many times the “lock-out” function was engaged.

### SUMMARY OF THE INVENTION

This invention is directed to a secure safe system including tamper detection in the preferred embodiments. The safe system includes an enclosure having an outer surface and an inner compartment accessible through a door, and a door lock mechanism. An access device is provided for unlocking the door lock mechanism, thereby enabling a user to gain access to the compartment. An electronic controller, disposed within the enclosure, is interconnected to the access device and the door lock mechanism. The controller is operative to receive a signal from the access device and unlock the door lock mechanism for an authorized user. The outer surface of the enclosure is touch sensitive, and the controller is further operative to determine if a person has touched the touch-sensitive surface and, if so, cause a safe-related function to be performed. The outer surface of the enclosure may be metallic, or the enclosure may be covered or coated with a touch-sensitive surface. In the preferred embodiments the access device is also touch-sensitive. The touch-sensitive surface is preferably capacitive touch-sensitive.

The controller is interconnected to an external source of power, and a battery disposed in the enclosure is recharged by the controller in the event that power is interrupted. The access device includes an illuminated keypad, in which case the safe-related function may include illuminating the keypad. The system may further including communications circuitry to which the controller is interconnected, and the safe-related function may include sending a signal to a receiver remote from the enclosure. Such a signal may be wired or wireless. The system may further include a memory to which the controller is interconnected, in which case the safe-related function may include sending event information to the memory. The controller may be further operative to store an event log in the memory regarding successful and unsuccessful attempts to unlock the door lock mechanism through the access device. The memory may also store multiple access codes for different authorized users. The system may further include an RFID sensor disposed within the enclosure, with the controller being operative to scan and store information regarding items placed and locked in the enclosure.

### BRIEF DESCRIPTION OF THE INVENTION

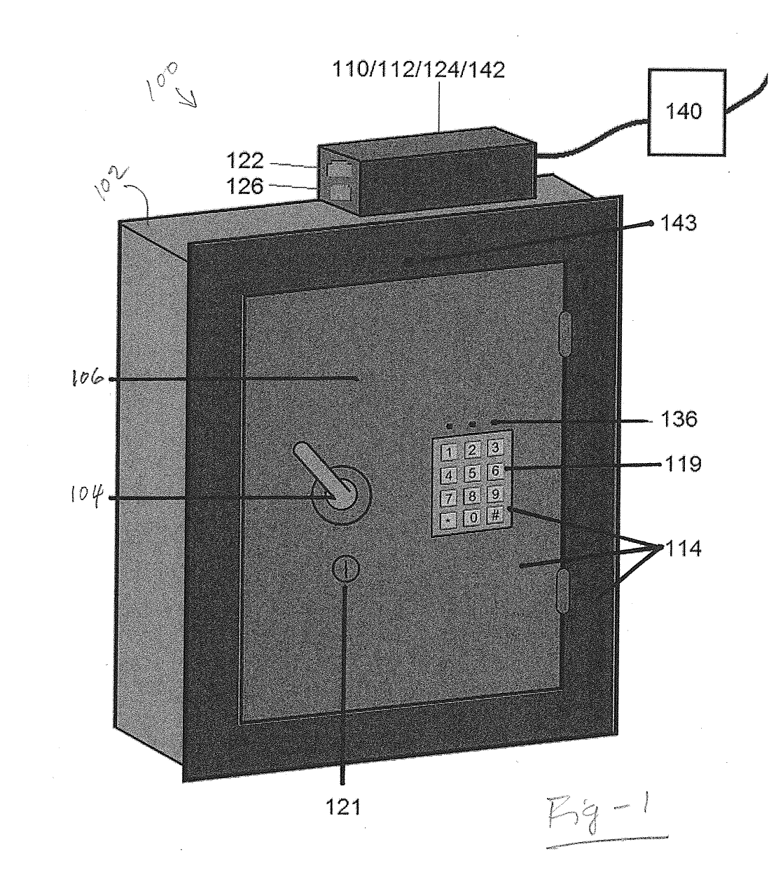

FIG. 1 is a perspective drawing of a safe unit constructed in accordance with the invention; and

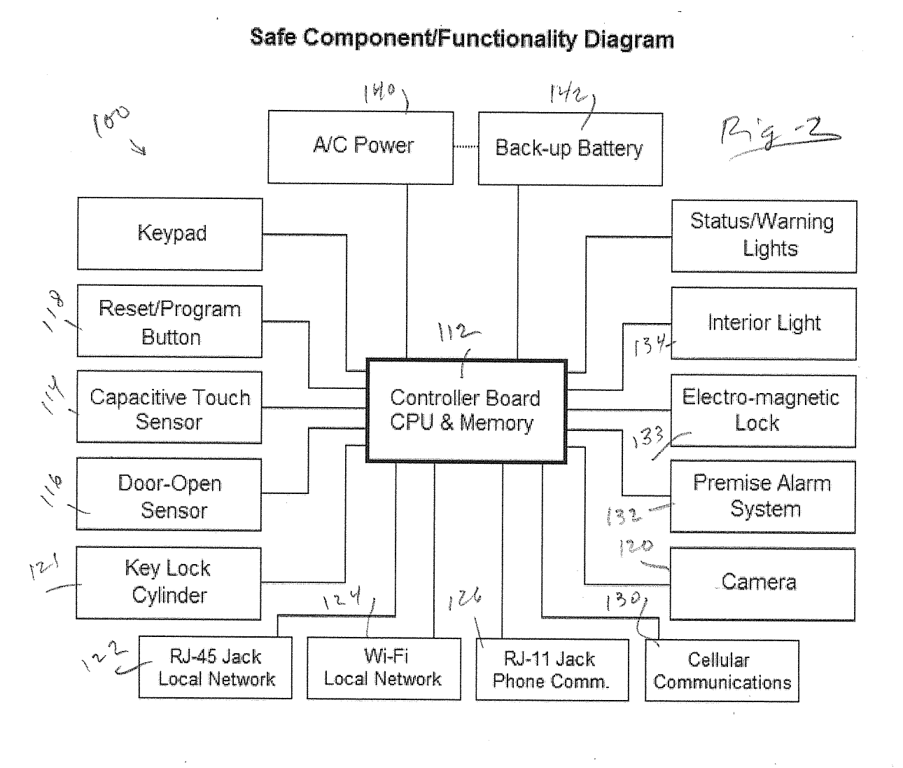

FIG. 2 is a block diagram of important functional components.

### DETAILED DESCRIPTION OF THE INVENTION

This invention improves upon existing safes with a combination of features that provide tamper-resistance and ultra-high security. As shown in FIG. 1, the safe (or stand-alone device to be installed in a pre-existing safe or container, hereafter referred to as the “safe-unit” 100) contains an enclosure 102 with an outer surface, an access device 104, and a control unit 110 internal to the enclosure.

The control unit includes a processing unit 122 and memory for logging, user administration of options, and event notifications, and smart decisions based on formulas of events and timing. Communication components network interface [wired and wireless], analog/voice phone, and/or a GSM/cellular), and various sensors, such as; capacitance sensor, door open/close sensor, key lock cylinder sensor.

The access device may be a keypad, key lock, combination dial, biometric device, or other appropriate mechanism. In contrast to existing systems, the entire outside surface of the unit is touch-sensitive. This includes the surface of the enclosure and the controls associated with the access method. In the preferred embodiments, these surfaces are made touch-sensitive using capacitive sensing technology. The outer surface of the enclosure is either metallic or coated with a touch-sensitive layer, and the keypad, lock, dial, biometric device, or other access device(s) is also rendered touch-sensitive.

FIG. 2 is a block diagram of the unit illustrating major components and attendant functionality. The controller 110 includes a controller board 112 including a processing unit and memory. The board 112 is interfaced to the capacitance touch sensors 114, door-open sensor 116, and reset/program button 118. The controller also receives signals from the keypad 119 (if used) and communicates with key lock cylinder 121 and/or electro-magnetic lock 133.

The controller also receives signals from a camera, and multiple data communication capabilities including one or more of an RJ-45 jack 122 to a local network; WiFi interface 124; RJ-11 phone jack 126; and cellular phone interface 130. The invention is not limited in terms of communications capabilities, and may take advantage of any existing or yet-to-be-developed technologies. The controller may further include an interface to a premise alarm system at 132, and may output current conditions to status/warning lights 136. The system is powered with an AC power transformer/input 140, but with long-lasting battery back-up 142 for added security. An interior light 134 comes on when the door 106 of the unit is opened.

Capacitive sensor(s) 114 detect if someone is touching any exposed surface of the unit, as well as the access control, cover over the video camera, etc. Upon detection of touch, the processing unit 112 will 1) illuminate the locking mechanism (digital keypad, combination lock dial, key bezel, biometric pad, or other devices used for limited access locking) 2) log the event, and 3) notify owner via a method(s) chosen by owner in device administration, such as SMS (text), email, prerecorded voice call, or smartphone app.

The use of touch-sensitive surfaces provides numerous advantages in accordance with the invention. Unless unarmed in advance, touching any part of the unit illuminates the keypad (or other access method), allowing the owner to utilize the keypad easily, and thereby access the safe-unit quickly and without turning on lights in the room. The capacitive sensing is also used in combination with various available communication methods providing the ability to notify the owner of specific events or combinations thereof in real-time. This solves several deficiencies of modern safes.

The unique and advantageous solution of using capacitive-sense in conjunction with access methods (keypad code inputs, door open, etc.) and communications allows the owner to receive immediate notification of the specific status of the unit as well as the ability to determine if immediate action is necessary. For example, if the safe-unit face, bezel, or keypad is touched, the owner is informed immediately. Additional individual notifications are sent to the owner if someone tried an invalid pin-code, a valid pin-code, and if the door was opened. The safe-unit would continue to send notifications for each new or repeated event. The safe-unit system will log each event with a date-time stamp, its type, and relevant information such as a specific pin code attempted.

If the safe-unit is hidden behind a picture, it can be assumed that no one except the owner or authorized persons would be touching the safe-unit, even accidentally. Of course there are always exceptions (maybe the housekeeper is dusting and moved the picture), but with the notification sent by the safe-unit, the owner would have knowledge of such an event, and be able make a decision of whether or not to investigate or take action. If the owner receives notification that the safe-unit was touched and then a short time later an invalid pin-code was attempted, he/she would have even more information to make a decision whether or not to investigate and/or take action. For instance, a home in which a troubled teenager resided, whereas the teenager decided to attempt different codes to access the safe-unit. With most safes the teenager could try many different pin-codes every day after school, and may eventually hit the correct pin-code. With this safe-unit the teenagers actions immediately known and intent would evident.

In addition, the ability of the safe-unit to use user-specific pin codes and the built-in camera would also either identify the person accessing the safe-unit or making the attempt, make it clear of intent if the camera was covered during such attempt, or give clues to how the pin-code may have been compromised by logging the attempted pin-code or valid pin-code used.

Furthermore, to make sure that the above features and notifications are not circumvented, there are 3 contingencies.

1) A “stay-alive” ping function that works with a smartphone app. If someone wanted to make access attempt and circumvent the notifications by disconnecting the safe-unit from the network switch or router, the smartphone app would detect lost communication by failure to receive a response from pings sent at preset intervals, and notify the owner.

2) The battery back-up in combination with event logging would circumvent attempts to stop notifications from being sent by cutting power to the unit or network. The safe-unit would continue to monitor itself and keep a log of events. Upon network power recovery, the unit would send the notifications. Event logs could also be viewed via the html interface via the LAN (local area network) at the owner's leisure.

3) To prevent attempted circumvention of both communications and power disruption and continue real-time notifications, an internal cellular/GSM unit would continue to send notifications via voice/SMS/data. The cellular/GSM unit may be built-in or may be an optional add-on connected via a USB port on the unit.

The combination of AC power with a battery back-up serves the secondary function of power reliability in emergency situation whereas the safe must be accessed immediately.

### Overview of Preferred and Alternative Embodiments

In broad and general terms, this invention applies to different types of safes, including wall, floor, and free-standing safes. In addition, the principles of this invention are applicable to secure inserts received by existing safes. Accordingly, in accordance with this disclosure, “safe” should be taken to include wall, floor, and free-standing safes, as well as inserts therefor. In preferred embodiments, these safes include some form of digital access method (keypad, biometric, etc.) and/or key locks.

Unique to the invention is touch-sensitive tamper notification. When the front-face, door or keypad (or other utilized electronic access method) is contacted by human touch, alarms may be generated, the event is logged, and a notification is sent to the safe owner/user via the communication(s) method chosen in the administration. Event logging keeps track of and saves data regarding sensor inputs (date/time stamped, which user or access code or attempted access code). Capacitive Sensing (touch-sensitive) may be provided on the front face bezel and/or door. Capacitive sensing also used for “tamper” network notifications.

Certain embodiments may include touch-sensitive keypad illumination. The keypad lights/illuminate upon contact of human touch to faceplate, bezel, door, keypad (or other utilized electronic access method) or unlocking handle. Interior LED lights (ON while door is open). A disable switch may be located on the door interior, or an ON/OFF switch located on door interior not operated by door) (optional auto disable when operating on battery back-up). A “door-open” sensor (magnetic contact or other) may be used to turn on interior lights. A “door-left-open” notification; door opened by key (keypad bypass) notification; and/or alarm system notification may be provided in accordance with appropriate parameters. Notification lights may be located on front of safe. Different colors, combinations of colors, or flashing to be alternate method of notification to owner/user of events or status. Alternatively, keys or keypad could be used as alternative method of notifications.

Communication components are provided to send notifications of events or predetermined combinations of events. Such components may include, without limitation, wired network(s), wi-fi, cellular phone, analog phone, and premise alarm connection(s). Event notifications may be delivered via email, SMS and DDNS Phone App connection (via home network wi-fi or wired, analog phone line, or cellular network).

The units are preferably AC powered with battery back-up. Safe electrical components are powered by premise wired AC electrical power. In the event of a premise wired AC power failure the safe will automatically switch to the built-in battery back-up power source. The system preferably remembers notification states after power loss (ex; invalid access attempt notification LED).

To ensure fail-safe operation, the safe battery is rechargeable and replaceable. Charging is controlled by the devices CPU by method known as “smart charging” to prevent overcharging. The CPU's smart charging method will also be able to detect decreased battery capacity (from age and/or use) and notify the owner/user that the battery is in need of replacement. Safe interiors may contain lights inside the body (storage area) to allow persons accessing the safe to better see its contents. When provided, light will illuminate when the door is open. This function can be limited to AC power operation only, AC and battery power, or turned off completely as chosen by owner/user.

Administration may be provided via html interfaces through standard wired/wireless network access. The owner/user can use a networkable device (such as a desktop PC, laptop, tablet or phone) that uses some form of internet browser software, to view/change administration settings (such as communication, network, notification types, notification messages, users, access codes, user permissions, interior lights, and power settings) and view logs. “Stay alive” constant monitoring of connections may be provided warn of disrupted communications. Phone software application sends ping to safe at predetermined intervals, safe answers ping. When no response to ping is received from the safe by the phone app, disrupted communications will be assumed and phone app will alert owner/user.

Certain embodiments may be multiple user access code/identification capable. That is, multiple users may be given access codes or can be granted access via other access methods that may be used (such as biometric finger prints). To be used for access/unlocking of safe, notifications and event logs stating which specific user accessed safe. To ensure premise security system compatibility, output connection(s) to be connected to premise alarm systems (for standard alarm system zone and/or duress).

Ultra-secure embodiments will provide cut-out deterrent systems. Reinforcement “rails” prevent or slow down process of safe being forcibly removed or cut out of wall. Elongated rails or bar-like structures attached to exterior of safe body sides and wall studs. Made from suitable material to make cutting by manual or machine methods as difficult as possible, and may be up to full height of wall studs. Provided structures may also contain wire that, when cut, will be part of the safes event notification system.

A peg-board system in rear wall and sides of the safe may be provided for accessory attachments (shelves, pistol holder, etc.) Holes in grid pattern allowing for flexibility of placement and a variety of, and different size, accessories. Holes may be threaded for secure attachment of accessories.

RFID sensors may be used to provide item inventory detection; that is, to track items with RFID tags placed in the safe. This capability may be used to view current contents of safe via html interface or mobile app, or for notification when RFID tagged item is removed from or placed in safe.

Notification of changes to admin may be generated to ensure seamless transitions between owners/users. “Old” contact info may be stored for future reference. A lock-out function may be used after X number of invalid attempts within a predetermined period of time. Lock-out can be reset manually by method yet to be determined (such as opening safe door with physical key or opening safe via electronic keypad and/or pressing reset button located inside safe). In addition, an html administration interface may effectuate lock-out after X number of invalid login attempts within a predetermined period of time. Lock-out can be reset manually by method yet to be determined (such as by manual safe access via key or keypad).

The systems are preferably direct wired (AC powered) with Battery back-up). A jack for an AC Adapter to power/recharge may be provide on front face of safe (in case of no in-wall wiring ability or in event of problem with in-wall wiring). Battery back-up will preferably be a standard rechargeable NiMH or Li-ion battery pack, or may be customized for device. Battery back-up may last several months without AC power supply for extended security in the event of a power loss. As such, in the event of a power loss from premise wired AC power supply everything will continue to operate normally under battery back-up with the following specifications. Other options include:

1) network connection will power off to reserve battery power (if network connection loss is detected);

2) Smart phone app will detect that there is no connection to safe and alert user;

3) Safe will continue to monitor trigger events (keypad attempts, capacitive sense, door openings, etc.);

If trigger event occurs, the safe will still:
a) log event; and
b) power on network connection (via battery) for just long enough to send alerts via sms, email, app, etc.

Upon AC power resumption, logged events will “sync” with app or be sent via notification methods.

### Typical Functions/Programming

A primary access code will be programmed for safe entry via specific method using the keypad in possible combination of other safe inputs, such as the reset button located inside safe. The owner/user enters access pin-code to unlock safe allowing door to be opened (or other “code” depending on method of digital access used, such as finger, thumb or hand print in the case of biometric digital access).

Network functions. log data, camera images, and safe settings are preferably accessible via local area network (LAN). Event logging may include valid access and invalid access attempts, by user access code, etc. Multiple users (non-admin) may be accommodated for access logging purposes. View/save camera images may be time-stamped and recorded by event (date and time). Wide Area Network (WAN) data may be limited to only outgoing for email/SMS/app and incoming ping for “stay-alive” function.

The primary password may be programmable via keypad as well as possibly through html/WAN administration. A button procedure may be provided for “Reset to Default”/set main pin# (lost password, must access via physical key)

### Event Notifications Sent by Safe Unit

Valid access via keypad (or other digital or biometric method)

Keypad bypassed access (door opened without use of use of keypad (or other digital or biometric method)

Invalid access attempt (incorrect access pin entered) (or invalid fingerprint or other biometric entered)

Lock-out has been enabled due to too many invalid pin-code access attempts

HTML administration lock-out has been enabled do to too many invalid password attempts

Capacitive/touch sense positive (tamper notification)

Pin change via keypad

Change made to administration and/or set-up. (if contact method is changed, notification is sent via old contact method(s) prior to completion of saving new settings.

Door left open. If door is left open for a specified period of time a notification is sent.

Diminished battery capacity. Batteries become old and wear out. When the batteries capacity falls below a predetermined level a notification is sent.

Emergency lock release via mobile app has been activated. Safe can be unlocked via the mobile app without revealing access pin-code. If this occurs, notification is sent.

AC power loss. If enough power left in back-up battery and connection is still live, notification is sent upon loss of premise wired AC power. If not enough power left in battery notification is sent upon resumption of power.

Duress signal—When specialized “duress” pin code is entered, door is unlocked AND device sends signal to premise alarm notifying alarm company that hostage/burglary situation is in progress. (Note: duress functions are common in monitored commercial alarm systems)

### Smartphone/Mobile Phone App

A smart or mobile phone “app” may be provided to receive some or all of the notifications from the safe as set forth above. Other capabilities may include the following:

“Stay-alive” function. The mobile app monitors the connection between itself and the safe by sending “pings” at specified intervals and awaits a response from the safe. If no response is received a connection failure is assumed and app user is notified (possible indications are that there is a power loss or communications failure at the safe).

Emergency remote lock release. The mobile app user may enter an access pin-code to unlock the safe remotely, and thereby not reveal the pin-code to the person it is being opened for.

Safe remembers notification state and events after power loss sends to app and other notification methods after AC power resumes.

### Camera Functionality

The unit may be provided with a camera to capture pictures of anyone attempting to open, or tampering with/touching, the safe. The camera records images at specified intervals (ex. 1 to 30 images per second). Images are temporarily stored for a specified amount of time (ex. 1 to 60 minutes) based on the size of an allocated portion of the devices memory for this purpose. The newest images replace the oldest on a rolling basis. At time of predetermined events, all current pictures/video are saved (removed from allocated rolling memory and saved for later viewing). Pictures can be viewed via app after user receives notification of event and/or user can view or download saved images from the safe via device connected to local network using the html administration interface.

### Physical Considerations

Safes and inserts constructed in accordance with this invention may be provided in various sizes and configurations. Wall, floor and free-standing configurations may be of varying depths, heights and widths, including small (i.e., square); medium (i.e., vertical rectangle), and rifle height. Floor safe configurations may be provided in multiple sizes including standard and rifle).

1. A secure safe system with tamper detection, comprising:
an enclosure having an outer surface and an inner compartment accessible through a door;
a door lock mechanism;
an access device for unlocking the door lock mechanism enabling a user to gain access to the compartment;
an electronic controller disposed within the enclosure, the controller being interconnected to the access device and the door lock mechanism, the controller being operative to receive a signal from the access device and unlock the door lock mechanism for an authorized user;
wherein at least a portion of the outer surface of the enclosure is touch sensitive; and
wherein the controller is further operative to determine if a person has touched the touch-sensitive surface and, if so, cause a safe-related function to be performed.

2. The secure safe system of claim 1, wherein:
the controller is interconnected to an external source of power; and
a battery disposed in the enclosure that is recharged by the controller in the event that power is interrupted.

3. The secure safe system of claim 1, wherein the outer surface of the enclosure is metallic, or the enclosure is covered or coated with a touch-sensitive surface.

4. The secure safe system of claim 1, wherein the access device is also touch-sensitive.

5. The secure safe system of claim 1, wherein:
the access device includes an illuminated keypad; and
the safe-related function includes illuminating the keypad.

6. The secure safe system of claim 1, further including communications circuitry to which the controller is interconnected; and
wherein the safe-related function includes sending a signal to a receiver remote from the enclosure.

7. The secure safe system of claim 1, wherein the signal is a wired or wireless signal.

8. The secure safe system of claim 1, further including a memory to which the controller is interconnected; and
wherein the safe-related function includes sending event information to the memory.

9. The secure safe system of claim 1, where in the touch-sensitive surface is capacitive touch-sensitive.

10. The secure safe system of claim 1, further including a memory to which the controller is interconnected; and
wherein the controller is operative to store an event log in the memory regarding successful and unsuccessful attempts to unlock the door lock mechanism through the access device.

11. The secure safe system of claim 1, further including a memory for storing multiple access codes for different authorized users.

12. The secure safe system of claim 1, further including a memory and an RFID sensor disposed within the enclosure; and
wherein the controller is operative to scan and store information regarding items placed and locked in the enclosure.

13. The secure safe system of claim 1, further including a camera having a field of view including a person attempting to use the access device.

14. The secure safe system of claim 1, wherein the safe-related function includes activation of a camera.

15. The secure safe system of claim 1, wherein the safe-related function includes activation of a camera having a field of view including a person attempting to use the access device.

16. The secure safe system of claim 1, further including a camera; and
wherein the electronic controller is further operative to identify the person accessing or attempting to access the system.

17. The secure safe system of claim 1, further including a camera; and
wherein the electronic controller is further operative to identify the person accessing or attempting to access the system using facial recognition.

18. The secure safe system of claim 1, wherein the safe-related function includes activation of a camera; and
wherein imagery acquired by the camera is recorded time-stamped and recorded by event (date and time).

19. The secure safe system of claim 1, further including a cut-out deterrent system including elongated rails or bar-like structures attached to exterior of safe body sides and wall studs; and
wherein the elongated rails or bar-like structures have a length up to the full height of the wall studs.

20. The secure safe system of claim 1, further including a cut-out deterrent system including structures attached to exterior of safe body sides and wall studs; and
wherein the structures also contain wire that, when cut, will be part of the safes event notification system.
